(19) United States
(12) Patent Application Publication
(10) Pub. No.: US 2003/0177745 A1
(43) Pub. Date: Sep. 25, 2003

(54) Filter device securing mechanism for an air cleaner

(76) Inventor: Tjoen Liang Jauw, Jakarta (ID)

Correspondence Address: CHARLES E. BAXLEY, 5th Floor, 59 John Street, New York, NY, 10038, US

(21) Appl. No.: 10/104,514

(22) Filed: Mar. 25, 2002

(51) Int. Cl. B01D 46/52

(52) U.S. Cl. 55/497; 55/502

(57) ABSTRACT

A filter device for an air cleaner includes a frame having four sides beams and four corner members. The beams each has an outer plate and two bars for forming a chamber and for receiving the peripheral portion of a filter element, and for preventing particles from bypassing the filter element and from entering into the air cleaner. An adhesive material may be engaged between the peripheral portion of the filter element and the beams for solidly securing the filter element to the beams. A peripheral member may secure the corner members and the beams together.

### BACKGROUND OF THE INVENTION

1. Field of the Invention

The present invention relates to a filter device, and more particularly to a filter device for an air cleaner or the like.

2. Description of the Prior Art

U.S. Pat. No. 4,790,863 to Nobiraki et al. discloses one of the typical air cleaners which comprises an HEPA (High Efficiency Particulate Air) filter disposed in front of a fan device for filtering purposes. However, the filter devices are normally and simply disposed in front of the fan device, without being suitably sealed to the. air cleaner or the like, such that great particles may also be drawn into the fan device and may damage the fan device some times.

The present invention has arisen to mitigate and/or obviate the afore-described disadvantages of the conventional air cleaners.

### SUMMARY OF THE INVENTION

The primary objective of the present invention is to provide a filter device for an air cleaner having a solidly securing or sealing structure for preventing particles from bypassing the filter device and from entering into the air cleaner.

In accordance with one aspect of the invention, there is provided a filter device for an air cleaner or the like. the filter device comprising a frame including four sides each having a beam provided therein. and including four corners each having a corner member provided therein, the beams each including an outer plate and a pair of bars extended therefrom for forming a chamber between the outer plate and the bars respectively, and a filter element including a peripheral portion engaged in the chambers of the beams, for allowing the filter element to be solidly retained in the frame and for preventing particles from bypassing the filter element and from entering into the air cleaner.

The bars each includes a serrated surface for engaging with the filter element and for retaining the filter element to the bars of the beams respectively.

The bars of the beams each includes a rib extended inward of the chamber of the beam for forming a channel in the beams respectively.

The corner members each includes two flaps extended therefrom and engaged into the beams for securing the beams and the corner members together.

A device is further provided for securing the filter element and the frame together and includes an adhesive material engaged into the chambers of the beams and engaged between the peripheral portion of the filter element and the beams for solidly securing the filter element to the beams of the frame.

The filter element includes a wavy structure having two end panels, the adhesive material is engaged between the end panels of the filter element and the outer plates of the beams for solidly securing the filter element to the beams of the frame.

A device is further provided for securing the beams and the corner members of the frame together and includes an arm extended from each of the beams and the corner members, and a peripheral member engaged onto the arms of the beams and the corner members for securing the beams and the corner members of the frame together.

The peripheral member includes a peripheral cavity formed therein for receiving the arms and for securing the peripheral member onto the beams and the corner members of the frame.

The arms each includes a lower portion having a slot formed therein, and an upper portion having a groove formed therein for receiving the peripheral member and for securing the peripheral member on the arms of the beams and the corner members.

The peripheral member includes a peripheral recess formed therein, the arms each includes a lock flange extended therefrom and engaged into the peripheral recess of the peripheral member, for solidly securing the peripheral member onto the beams and the corner members.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a filter device for an air cleaner in accordance with the present invention;

FIG. 2 is an enlarged partial perspective view of the filter device;

FIG. 3 is an enlarged partial exploded view of the filter device:

FIGS. 4, 5 are partial cross sectional views taken along lines 4-4 and 5-5 of FIG. 1 respectively;

FIGS. 6, 7 are partial cross sectional views similar to FIG. 4, illustrating the other embodiments of the filter device; and

FIG. 8 is an enlarged partial perspective view similar to FIG. 2, for illustrating the filter device as shown in FIG. 7.

### DETAILED DESCRIPTION OF THE PREFERRED EMBODIMENT

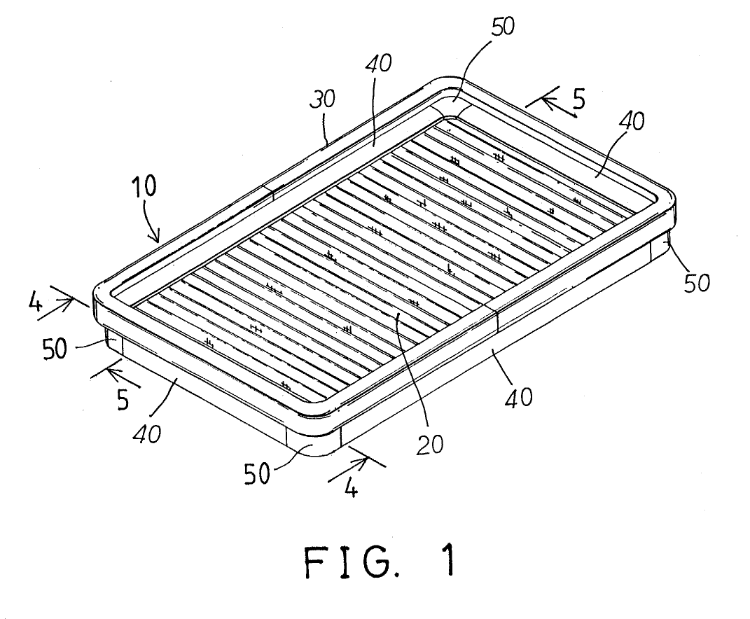

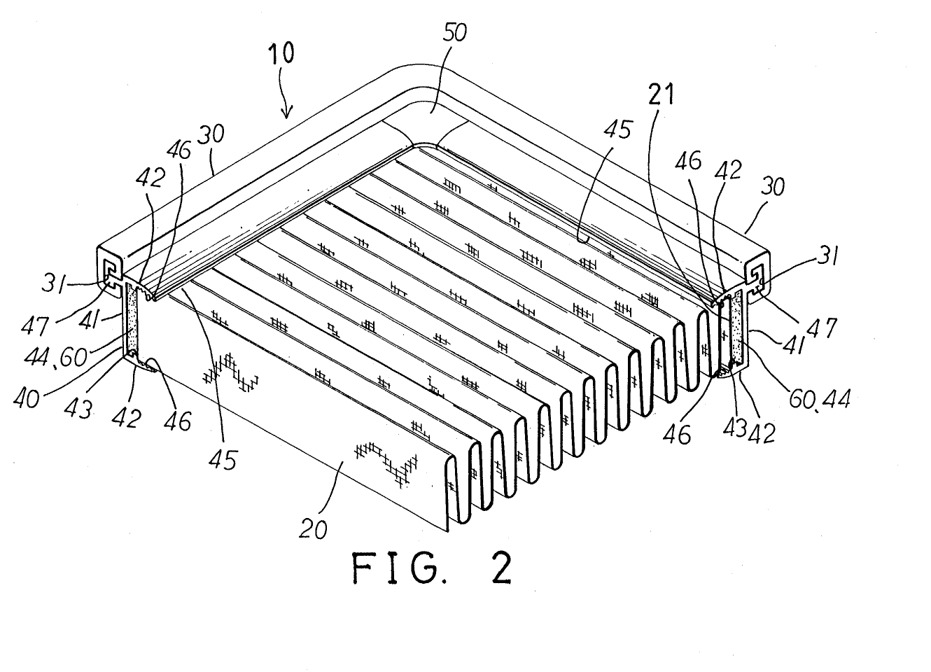

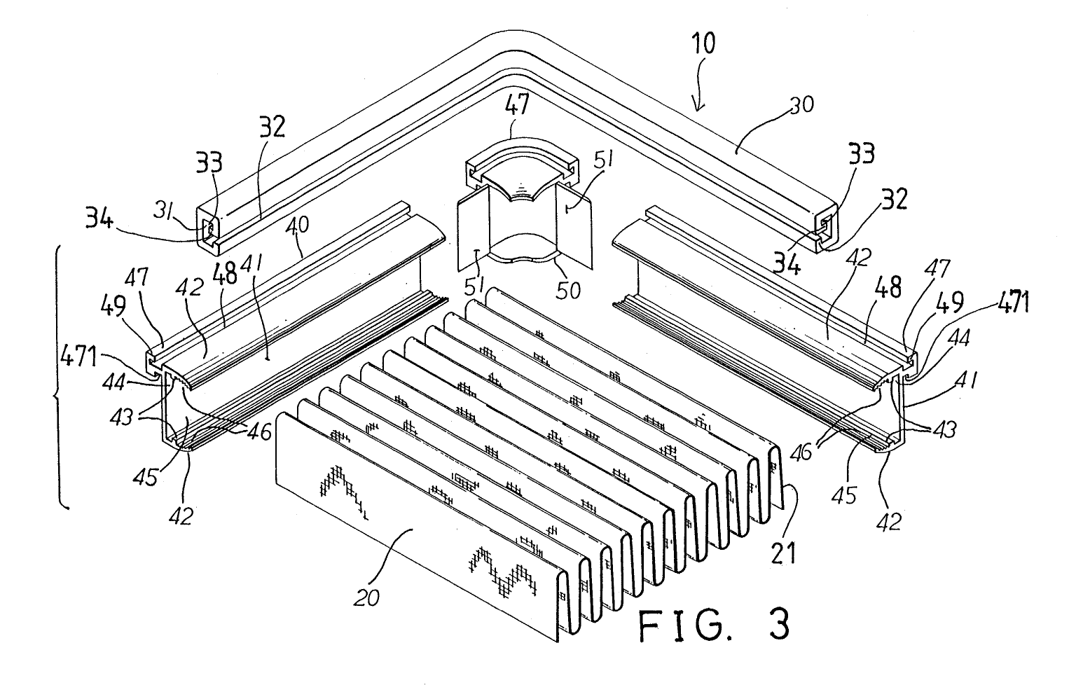

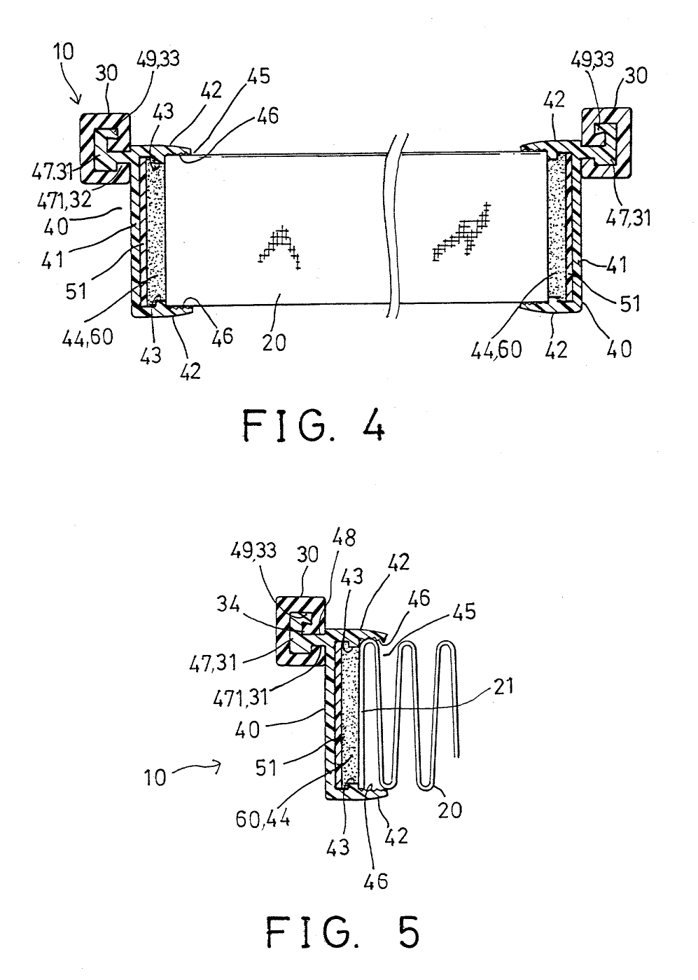

Referring to the drawings, and initially to FIGS. 1-5, a filter device in accordance with the present invention is provided for attaching into an air cleaner (not shown) and comprises a peripheral frame 10, and a filter element 20, such as an HEPA (High Efficiency Particulate Air) filter disposed in the peripheral frame 10 for filtering purposes. The filter element 20 includes a wavy structure having two planer end panels 21 (FIGS. 2, 3, 5, 8) to be received in and secured to the peripheral frame 10. The frame 10 includes four or two pairs of side beams 40, and four corner members 50 each having two flaps 51 extended therefrom and perpendicular to each other for engaging into every two adjacent beams 40, best shown in FIG. 3.

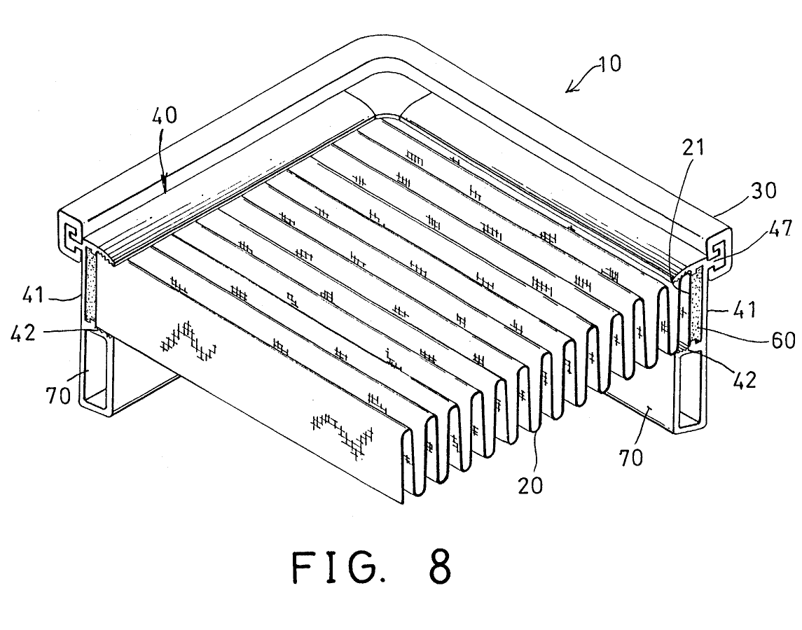

The beams 40 each includes an outer plate 41, and two bars 42 extended inward of the frame 10 and substantially parallel to each other for forming or defining a chamber 45 between the outer plate 41 and the bars 42, and for receiving the peripheral portion and/or the end panels 21 of the filter element 20. The bars 42 each includes a free end portion having a serrated surface 46 formed in the inner portion thereof for engaging with the filter element 20 and for preventing the outer peripheral portion of the filter element 20 from slipping or moving relative to the beams 40 of the peripheral frame 10. As shown in FIGS. 7 and 8, the beams 40 and/or the corner members 50 may each include a hollow conduit 70 attached to or extended from one of the bars 42 for allowing the filter device to be engaged into or attached to different kinds of air cleaners or the like.

The bars 42 of the beams 40 each further includes a rib 43 extended inward of the chamber 45 of the respective beams 40, preferably extended from the middle portion of the bars 42, or preferably located close to the outer plate 41, for forming or defining a channel 44 between the ribs 43 and the outer plate 41, and for receiving the flaps 51 of the corner members 50 respectively, and for preventing the flaps 51 from moving relative to the beams 40 and for solidly securing the corner members 50 to the beams 40. The flaps 51 of the corner members 50 may be solidly secured to the beams 40 with such as a force-fitted engagement, latches, fasteners, or the like.

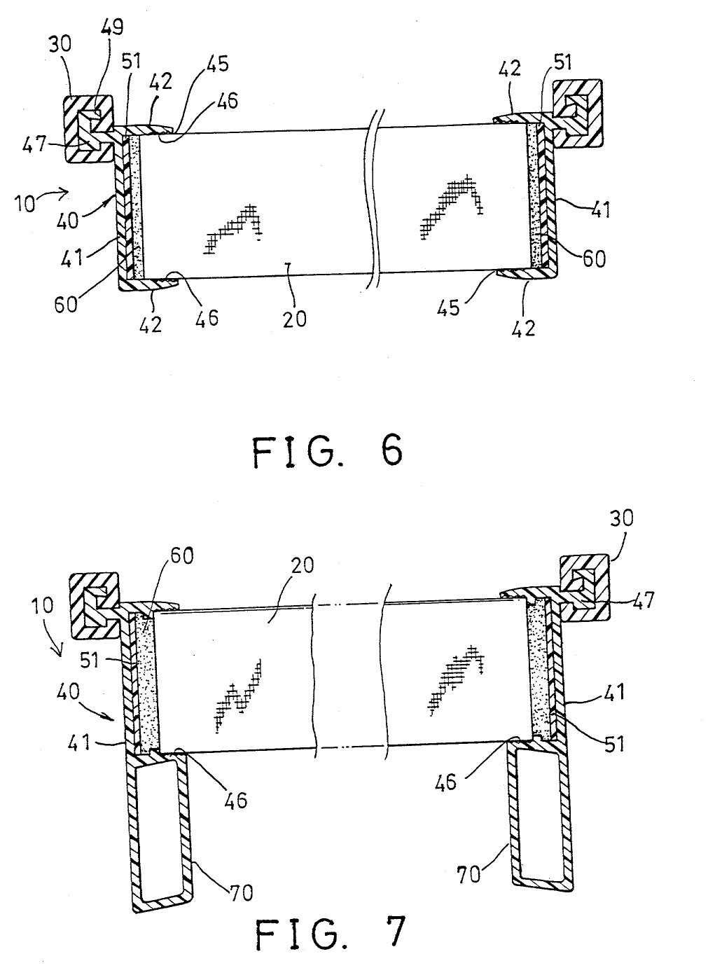

As best shown in FIGS. 2, and 4-8, an adhesive material 60 is further provided and applied or filled into the channel 44 and/or the chamber 45 of the respective beam 40, and engaged with the outer peripheral portion and/or the end panels 21 of the filter element 20, and/or the bars 42, and/or the ribs 43, and/or the outer plate 41, and/or the flaps 51 of the corner members 50, for further solidly securing the beams 40 and the corner members 50 and the filter element 20 together. As shown in FIG. 6, without the ribs 43, the beams 40 and the corner members 50 and the filter element 20 may also be solidly secured together with the adhesive materials 60.

As shown in the drawings, the beams 40 and the corner members 50 each includes an arm 47 extended outward from the upper and the outer peripheral portion thereof. The arms 47 each includes a slot 471 and a groove 48 formed in the bottom portion and the upper portion thereof respectively, and each further includes an inverted L-shaped lock flange 49 extended inward of the groove 48 thereof. The filter device further includes a resilient and protective peripheral member 30 having a peripheral cavity 31 formed therein for receiving the arm 47 and having a bottom flange 32 for engaging into the slot 471 of the arm 47 and for securing the peripheral member 30 onto the beams 40 and the corner members 50 of the peripheral frame 10, and for further retaining or securing the beams 40 and the corner members 50 of the peripheral frame 10 together.

The peripheral member 30 is preferably made of rubber or plastic or the other resilient materials, for suitably engaging with the air cleaner and for making a suitable air tight or water tight seal between the peripheral frame 10 and the air cleaner. The peripheral member 30 may further include a peripheral recess 33 formed therein and formed or defined by a peripheral extension 34 which may be received in the groove 48 of the arm 47. The lock flanges 49 of the arms 47 and the corner members 50 may be engaged into the peripheral recess 33 of the peripheral member 33 for further solidly securing the beams 40 and the corner members 50 of the peripheral frame 10 together.

It is to be noted that the filter element 20 may be solidly retained between the beams 40 and the corner members 50, and may further be solidly secured between the beams 40 and the corner members 50 by adhesive materials. The peripheral member 30 may further be provided for solidly securing the beams 40 and the corner members 50 of the peripheral frame 10 together and for making a suitable air tight or water tight seal between the peripheral frame 10 and the air cleaner.

Accordingly, the filter device in accordance with the present invention includes a solidly securing or sealing structure for preventing particles from bypassing the filter element and from entering into the air cleaner.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A filter device comprising:
a frame including four sides each having a beam provided therein, and including four corners each having a corner member provided therein, said beams each including an outer plate and a pair of bars extended therefrom for forming a chamber between said
outer plate and said bars respectively, and a filter element including a peripheral portion engaged in said chambers of said beams, for allowing said filter element to be solidly retained in said frame.

2. The filter device according to claim 1, wherein said bars each includes a serrated surface for engaging with said filter element and for retaining said filter element to said bars of said beams respectively.

3. The filter device according to claim 1, wherein said bars of said beams each includes a rib extended inward of said chamber of said beam for forming a channel in said beams respectively.

4. The filter device according to claim 1. wherein said corner members each includes two flaps extended therefrom and engaged into said beams for securing said beams and said corner members together.

5. The filter device according to claim 1 further comprising means for securing said filter element and said frame together.

6. The filter device according to claim 5, wherein said securing means includes an adhesive material engaged into said chambers of said beams and engaged between said peripheral portion of said filter element and said beams for solidly securing said filter element to said beams of said frame.

7. The filter device according to claim 6, wherein said filter element includes a wavy structure having two end panels, said adhesive material is engaged between said end panels of said filter element and said outer plates of said beams for solidly securing said filter element to said beams of said frame.

8. The filter device according to claim 1 further comprising means for securing said beams and said corner members of said frame together.

9. The filter device according to claim 8, wherein said securing means includes an arm extended from each of said beams and said corner members, and a peripheral member engaged onto said arms of said beams and said corner members for securing said beams and said corner members of said frame together.

10. The filter device according to claim 9, wherein said peripheral member includes a peripheral cavity formed therein for receiving said arms and for securing said peripheral member onto said beams and said corner members of said frame.

11. The filter device according to claim 9, wherein said arms each includes a lower portion having a slot formed therein, and an upper portion having a groove formed therein for receiving said peripheral member and for securing said peripheral member on said arms of said beams and said corner members.

12. The filter device according to claim 11, wherein said peripheral member includes a peripheral recess formed therein, said arms each includes a lock flange extended therefrom and engaged into said peripheral recess of said peripheral member, for solidly securing said peripheral member onto said beams and said corner members.
